(19) United States
(12) Patent Application Publication
(10) Pub. No.: US 2026/0027456 A1
(43) Pub. Date: Jan. 29, 2026

(54) METHOD AND SYSTEM FOR MANAGING AN ELECTRONIC GAME BASED ON RECORDING ELECTRONIC TRANSACTIONS

(71) Applicant: SAUDI ARABIAN OIL COMPANY, Dhahran (SA)

(72) Inventors: Nouf A. Hakbani, Dhahran (SA); Elmer D. Dimayuga, Al Khobar (SA)

(73) Assignee: SAUDI ARABIAN OIL COMPANY, Dhahran (SA)

(21) Appl. No.: 18/783,956

(22) Filed: Jul. 25, 2024

(51) Int. Cl. A63F 13/30; G06F 3/0488; G06Q 20/34; G09B 19/18

(52) U.S. Cl. CPC A63F 13/30; G06F 3/0488; G06Q 20/351; G09B 19/18

(57) ABSTRACT

A method may include obtaining various user requests to participate in an electronic game. The method may further include determining a selection of digital transaction cards for the electronic game based on a business game type. The method may further include obtaining a digital transaction card among the digital transaction cards for a game round of the electronic game. The method may further include presenting an electronic ledger in a graphical user interface that is displayed on a user device in response to obtaining the digital transaction card. The method may further include recording, in response to a user input to the graphical user interface, a digital transaction in an electronic ledger based on the digital transaction card. The method may further include determining whether a player associated with the user device satisfies a winning criterion based on an electronic business statement.

### BACKGROUND

Games have been used for educational purposes in the past, such as buying and selling real estate in the traditional Monopoly boardgame. However, such boardgames are often predictable for game players and typically avoid game play that teaches real-world principles.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining, over a computer network and from various user devices, various user requests to participate in an electronic game. The method further includes determining, by a computer processor, a business game type for the electronic game. The method further includes determining, by the computer processor, a selection of digital transaction cards for the electronic game based on the business game type. The method further includes determining, by the computer processor, a selection of a time period for the electronic game. The method further includes obtaining a digital transaction card among the digital transaction cards for a game round of the electronic game. The method further includes presenting, by the computer processor, an electronic ledger in a graphical user interface that is displayed on a user device among the user devices in response to obtaining the digital transaction card. The method further includes recording, by the computer processor and in response to a user input to the graphical user interface, a digital transaction in an electronic ledger based on the digital transaction card and in response to presenting the electronic ledger in the graphical user interface. The method further includes determining, by the computer processor, an electronic business statement based on various electronic transactions. The electronic transactions are recorded in the electronic ledger for the time period. The method further includes determining, by the computer processor, whether a player associated with the user device satisfies a winning criterion based on the electronic business statement.

In general, in one aspect, embodiments relate to a system that includes a computer network, various user devices coupled over the computer network, and an electronic game manager coupled to the user devices over the computer network. The electronic game manager includes a computer processor. The electronic game manager obtains, over the computer network and from the user devices, various user requests to participate in an electronic game. The electronic game manager further determines a business game type for the electronic game. The electronic game manager further determines a selection of digital transaction cards for the electronic game based on the business game type. The electronic game manager further determines a selection of a time period for the electronic game. The electronic game manager further obtains a digital transaction card among the digital transaction cards for a game round of the electronic game. The electronic game manager further presents an electronic ledger in a graphical user interface that is displayed on a user device among the user devices in response to obtaining the digital transaction card. The electronic game manager further records, in response to a user input to the graphical user interface, an electronic transaction in an electronic ledger based on the digital transaction card and in response to presenting the electronic ledger in the graphical user interface. The electronic game manager further determines an electronic business statement based on various electronic transactions. The electronic transactions are recorded in the electronic ledger for the time period. The electronic game manager further determines whether a player associated with the user device satisfies a winning criterion based on the electronic business statement.

In some embodiments, a graphical user interface (GUI) is presented on a touchscreen using various GUI components. A user input may be a touch input to at least one GUI component among the GUI components in the touchscreen. In some embodiments, a server is connected to a computer network and obtains various user requests from various user devices. The user requests may correspond to various business game types. A first set of the user devices may be assigned by the server to an electronic manufacturing game based on a first set of user requests being associated with a manufacturing game type. A second set of the user devices may be assigned by the server to an electronic merchandising game based on a second set of the user requests being associated with a merchandising game type. The business game types may include the manufacturing game type and the merchandising game type.

In some embodiments, a recorded electronic transaction from a user device is obtained by a server. The recorded electronic transaction may be based on a user input in response to presenting an electronic ledger in the graphical user interface. The server may determine whether the recorded electronic transaction satisfies a predetermined accounting rule for the electronic game. The server may update a game position of the user device in the electronic game in response to the recorded electronic transaction failing to satisfy the predetermined accounting rule. In some embodiments, a user balance is determined for a user device based on various recorded electronic transactions associated with an electronic ledger. The user balance may be presented to various user devices during a game round in a graphical user interface. A determination may be made whether the user balance satisfies a winning criterion. An electronic game for the user device may be terminated in response to the user balance failing to satisfy the winning criterion.

In some embodiments, a winning criterion corresponds to a positive cash amount. An electronic game may be terminated for a user device in response to a negative cash amount. In some embodiments, a winning criterion corresponds to a user device among various user devices with a highest net income among various valid recorded transactions in an electronic ledger. In some embodiments, various digital transaction cards include a first digital transaction card and a second digital transaction card. The first digital transaction card may correspond to a payment of a player liability by a first user during a predetermined first day within the time period. The second digital transaction card may correspond to receipt of a payment for a player service by the first user during a predetermined second day within the time period. In some embodiments, a player token is determined for a user device. A digital transaction card is obtained using a virtual wheel feature in response to disposing the player token on a predetermined day within a time period. An electronic transaction may be performed on the predetermined day for the user device based on the digital transaction card.

In some embodiments, a second digital transaction card is obtained using a second virtual wheel feature in response to obtaining a first digital transaction card using a first virtual wheel feature. The first digital transaction card may correspond to a payment of a player liability and the second digital transaction card corresponds to a cost of the player liability. In some embodiments, various game operations are performed by various game players over a time period. The game operations may be administered by an electronic game manager. In some embodiments, a user device includes a touchscreen. A graphical user interface may be presented on the touchscreen using various GUI components. A user input may be a touch input to at least one GUI component among the GUI components in the touchscreen.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIGS. 2, 3, 4, 5A, 5B, 6A, 6B, 6C, 6D, 6E, 6F, 6G, 6H, 6I, 6J, and 6K show examples in accordance with one or more embodiments.

FIG. 7 shows a flowchart in accordance with one or more embodiments.

FIG. 8 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for operating one or more electronic games according to various business game types, such as based on bookkeeping principles. In some embodiments, for example, an electronic game manager administers an electronic game using digital transaction cards and one or more virtual wheel features. More specifically, the electronic game manager may transmit game management data to multiple user devices to implement electronic games that provide educational tools, such as for teaching basic accounting, using transactional rules (e.g., principles of debit and credit in a basic service business) associated with a particular type of business. Additionally, game players may perform electronic transactions with other game players depending on the business game type. As such, some embodiments may have players maximize game income among other game players in order to understand financial principles and business strategy.

Moreover, users may record different electronic transactions using a graphical user interface (GUI). As such, users may provide user inputs to an electronic ledger within the GUI in order to record such electronic transactions during an electronic game. After recordation, recorded electronic transactions may be automatically validated according to various transaction rules, such as using validation requests transmitted from user devices to a server on a computer network. Likewise, some embodiments have game players analyze recorded transactions from other game players in order to identify improper recorded transactions and/or correct the electronic transaction entered into the electronic ledger. Likewise, electronic transactions may use random numerical amounts (e.g., based on a spinning operation with one or more virtual wheel features) rather than fixed amounts in order to avoid player memorization of past recorded transactions.

In some embodiments, an electronic game is based on real-world bookkeeping scenarios, where electronic transactions are recorded at predetermined intervals (e.g., daily) to provide status updates for a business in the electronic game. For example, the electronic game may be turn-based where different game rounds correspond to different business days. Thus, various player spaces along a player track may define a time period for starting and ending an electronic game. On the other hand, an electronic game may be performed in real-time where one human calendar day corresponds to one day within the electronic game (e.g., for a social networking game played by users on a social networking platform). As such, some game players may be penalized for failing to login in order to record a daily electronic transaction. Likewise, other chronological periods are contemplated for recordation, such as weeks, months, and years.

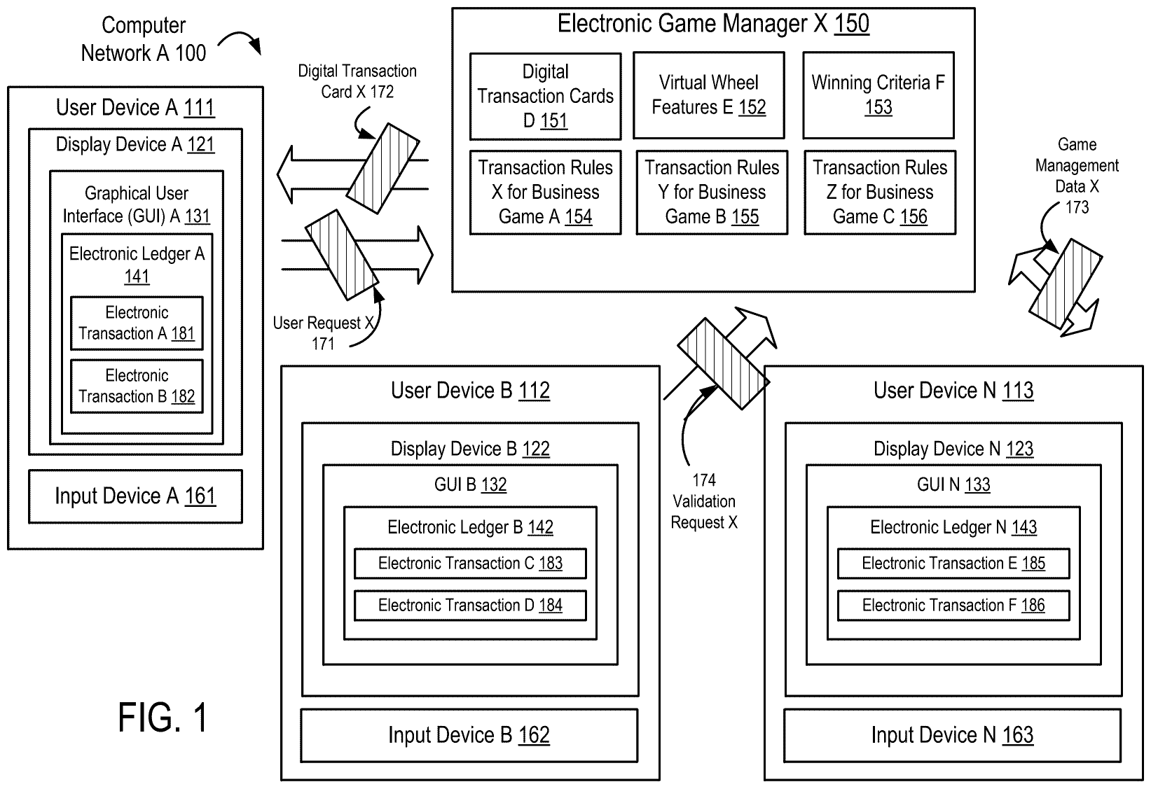

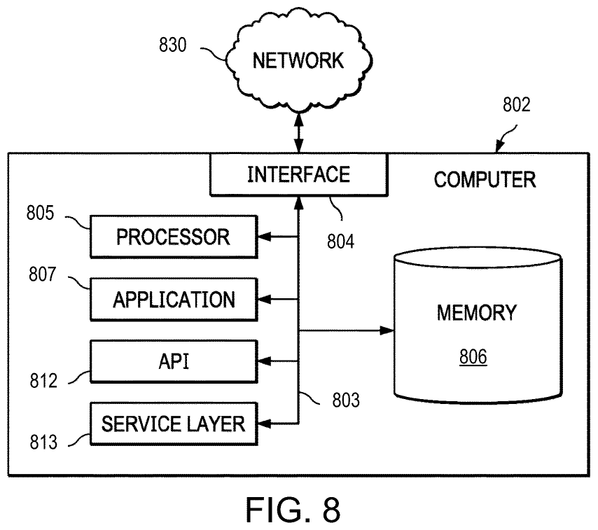

Turning to FIG. 1, FIG. 1 shows a schematic diagram in accordance with one or more embodiments. As shown in FIG. 1, a computer network (e.g., computer network A (100)) may include various user devices (e.g., user device A (111), user device B (112), user device N (113)), various network elements (not shown), and/or one or more electronic game managers (e.g., electronic game manager X (150)). User devices may include personal computers, smartphones, smart watches, human machine interfaces, and any other devices coupled to a computer network that obtain user inputs from one or more users. The user devices may include one or more input devices (e.g., input device A (161), input device B (162), input device N (163)), one or more display devices (e.g., display device A (121), display device B (122), display device N (123)), and hardware and/or software with functionality for providing a graphical user interface (GUI) (e.g., GUI A (131), GUI B (132), GUI N (133)). Examples of input devices may include a keyboard, a mouse, and various game controllers, such as a joystick or other game apparatus (e.g., a touchpad, a touch controller for a virtual reality and/or augmented reality system, a microphone, etc.). For example, an input device may include one or more analog sticks, one or more physical buttons, optical sensing devices, and touch sensing devices. A user device may also include other output devices in addition to a display device, such as one or more speaker devices, a headset, and one or more haptic devices. A network element may refer to various hardware components within a computer network, such as switches, routers, and hubs, as well as user devices, servers, network storage devices, user equipment, or any other logical entities for uniting one or more physical devices on the computer network, such as the Internet. Electronic game managers, user devices, and network elements may be computer systems similar to the computer system (802) described in FIG. 8 below and the accompanying description.

Turning to electronic game managers, an electronic game manager (e.g., game manager X (150)) may include hardware and/or software for administering one or more electronic games for one or more user devices. For example, an electronic game manager may include one or more servers that generate game sessions for multiple users to play an electronic game. More specifically, a game manager may obtain user requests (e.g., user request X (171)) from multiple user devices requesting access to an existing electronic game or to participate in a new electronic game. An electronic game manager may receive and/or transmit game management data (e.g., game management data X (173)) for performing game operations to implement one or more electronic games. For example, game management data may include user identification information, game status updates, game history for current and past electronic games, past and ongoing game operations, and player information. Game management data may be obtained automatically in real-time from various user devices associated with game players as well as at predetermined intervals (e.g., after an electronic game ends or prior to initiate a game session).

Moreover, an electronic game manager may be implemented using a hardware server for implementing online multiplayer games as well as part of a social networking system, an electronic messaging system, or other type of networking system over which a community of users and co-users may share and access game content. In some embodiments, an electronic game manager refers to a native or hybrid application installed on a respective user device. Likewise, an electronic game manager may communicate with various user devices over a web browser through a website associated with a particular electronic game. In some embodiments, an electronic game manager implements a virtualized game environment that users may access to communicate with other game players, such as in a digital forum or other virtual space. A virtualized game environment may include a chat room, instant messaging forum, and a social networking group space for an electronic game.

Turning to graphical user interfaces (GUIs), a GUI may be hardware and/or software that includes functionality for presenting data and/or receiving user inputs from a user regarding an electronic game. For example, a GUI may include various graphical icons and other GUI components to submit user requests to join and/or exit an electronic game. A GUI may also provide one or more graphical indicators, such as GUI components that provide game activity reports, automate game operations, and GUI fields that obtain user inputs to implement game decisions for an electronic game. For example, a turn indicator in a GUI may provide a clear visual indication showing which game player's has possession of the current turn. Moreover, some electronic games may be operated by multiple game players simultaneously, where different game players perform their turns in parallel during a particular game round. Some electronic games may be played amongst groups (e.g., where multiples users may manage one group against another group that also include one or more users). As such, a GUI may include hardware and/or software for communicating amongst group members in order to manage game decisions, such as dividing responsibility among recording electronic transactions.

In some embodiments, an electronic game uses one or more electronic ledgers (e.g., electronic ledger A (141), electronic ledger B (142), electronic ledger N (143)) for recording one or more electronic transactions (e.g., electronic transaction A (181), electronic transaction B (182), electronic transaction C (183), electronic transaction D (184), electronic transaction E (185), electronic transaction F (186)). In particular, an electronic ledger may be implemented using hardware and/or software using a GUI to record an electronic transaction based on user inputs. For example, an electronic ledger may include various input fields where a user may provide game information in response an electronic transaction during a specific game. For illustration, an electronic accounting game may require a game player to record an accountant transaction based on current game information and particular transaction rules (e.g., transaction rules X (154) for business game A, transaction rules Y (155) for business game B, and transaction rules Z (156) for business game C).

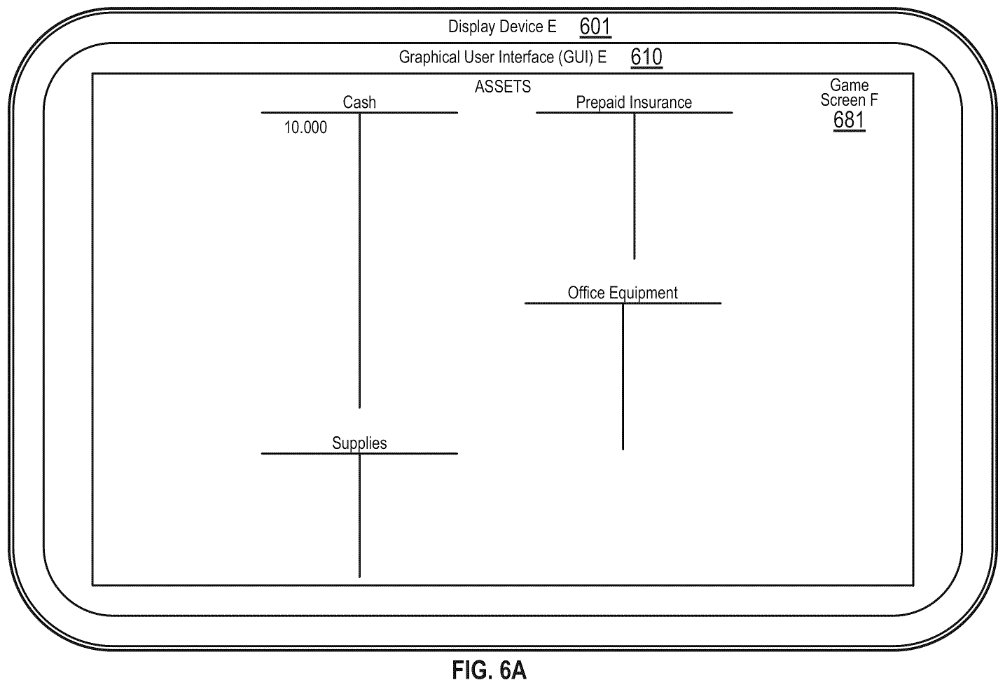

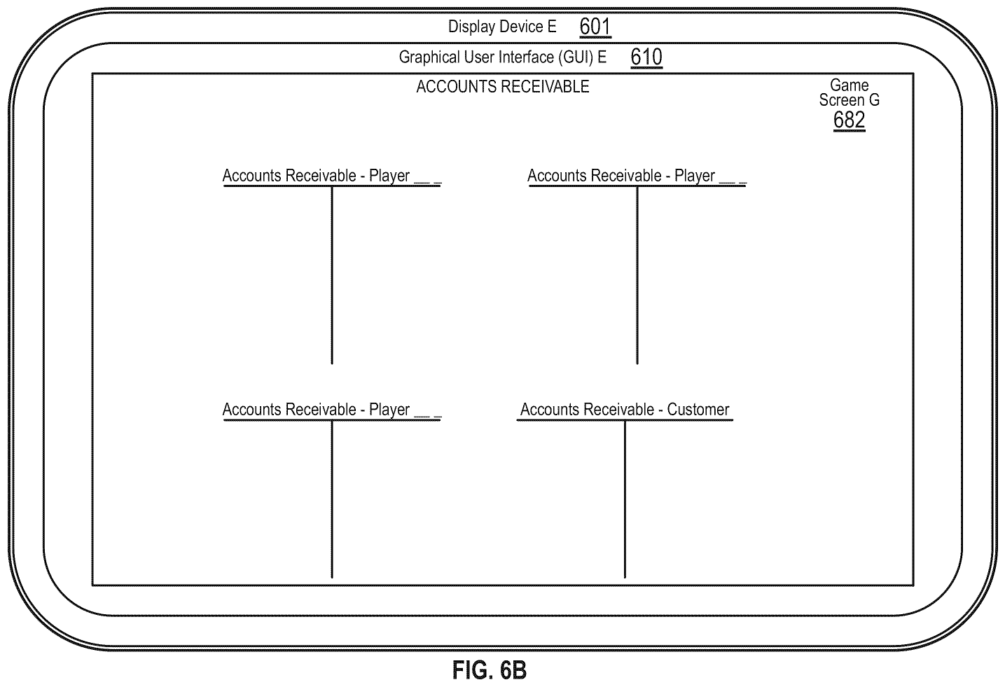

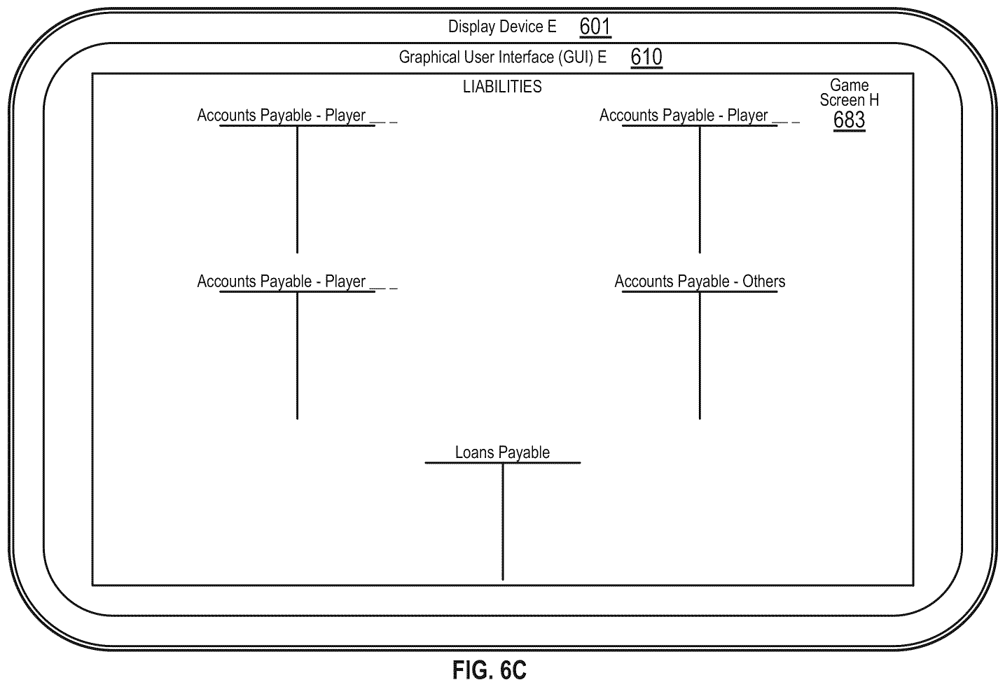

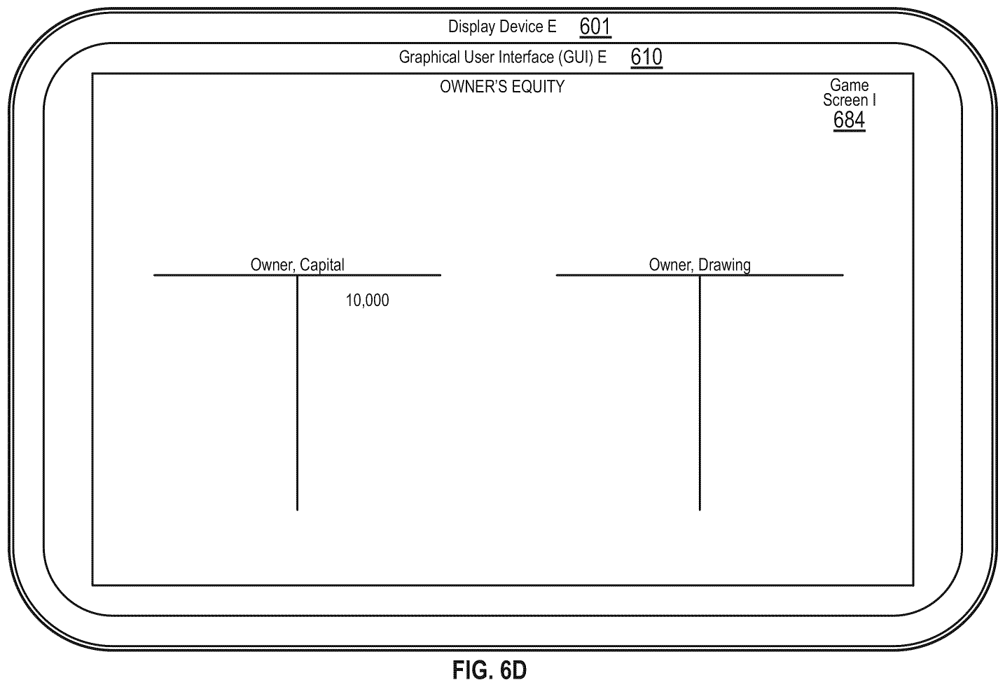

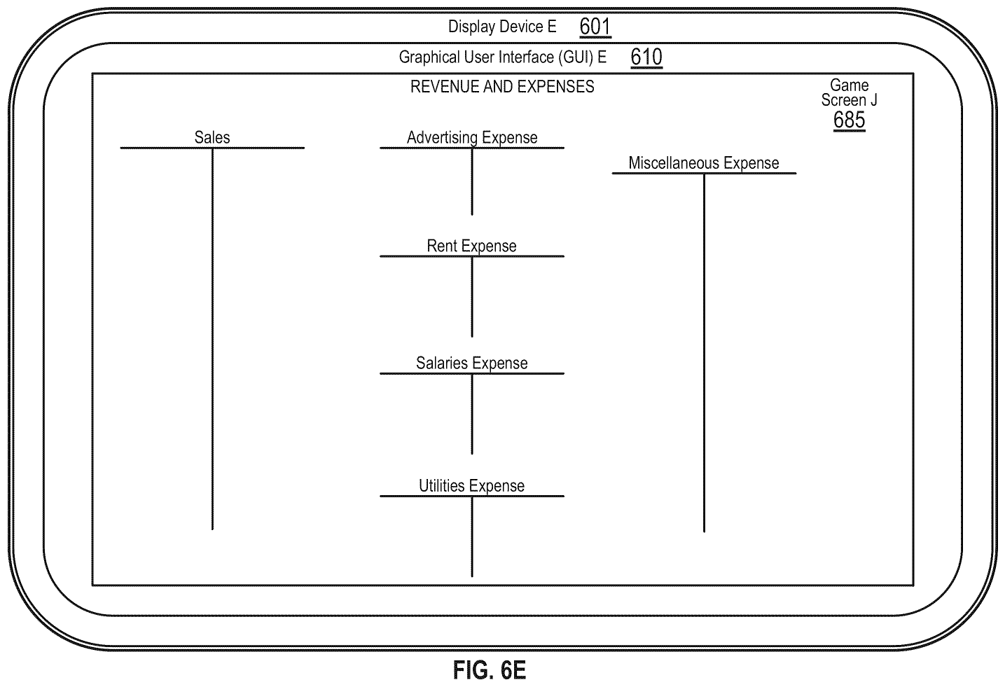

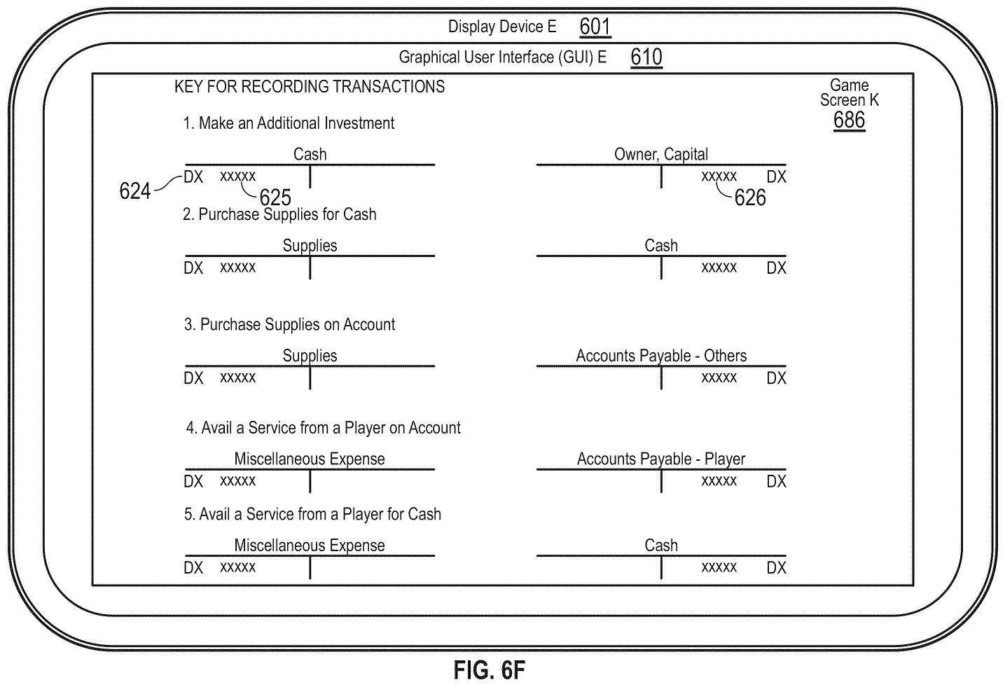

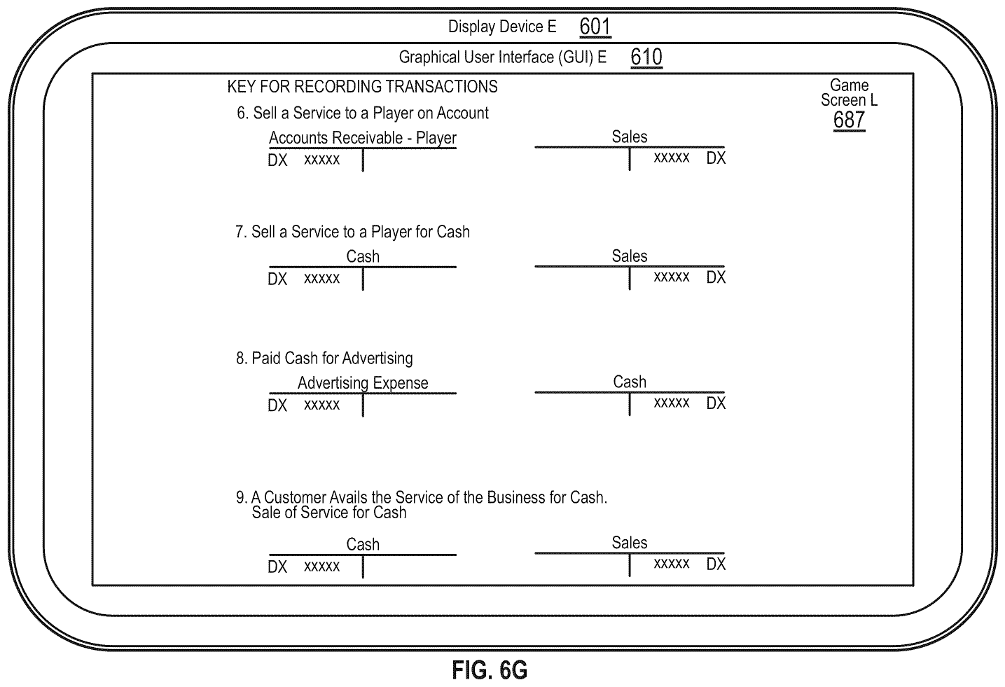

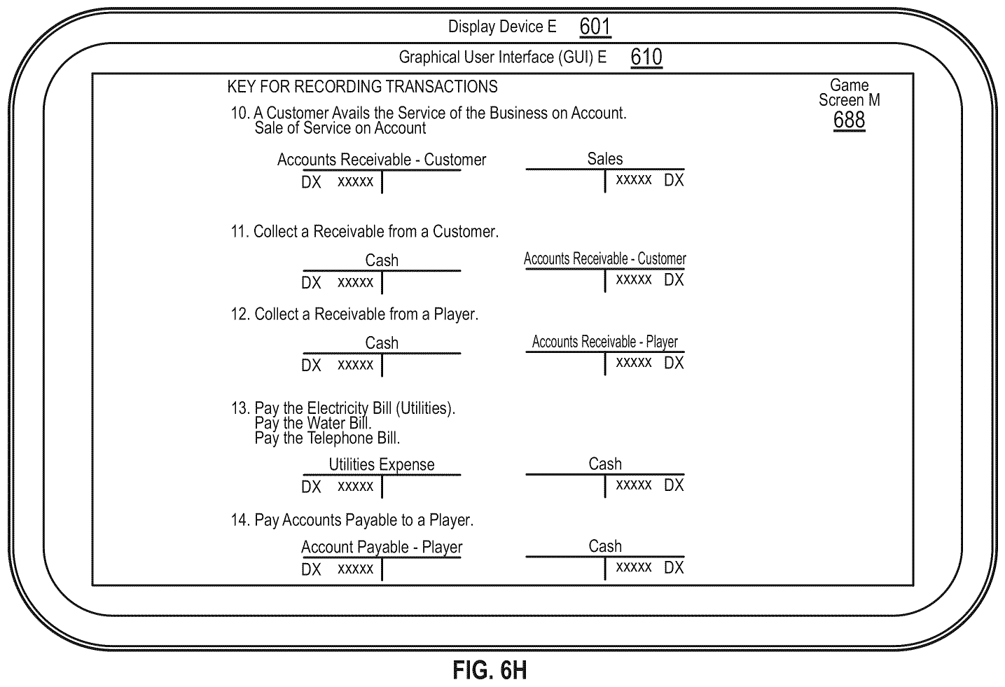

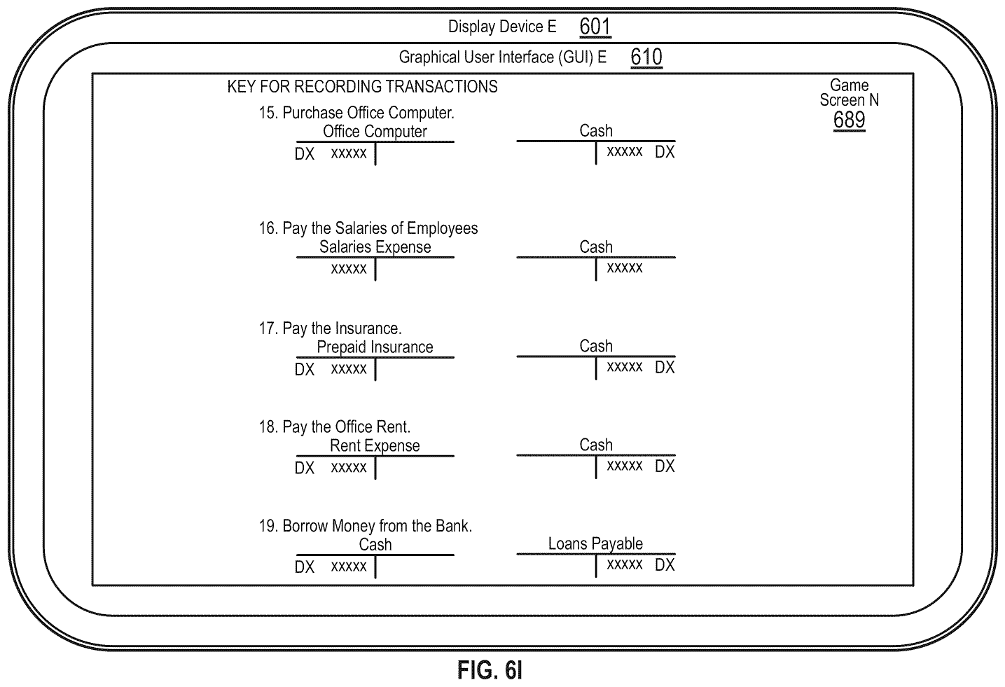

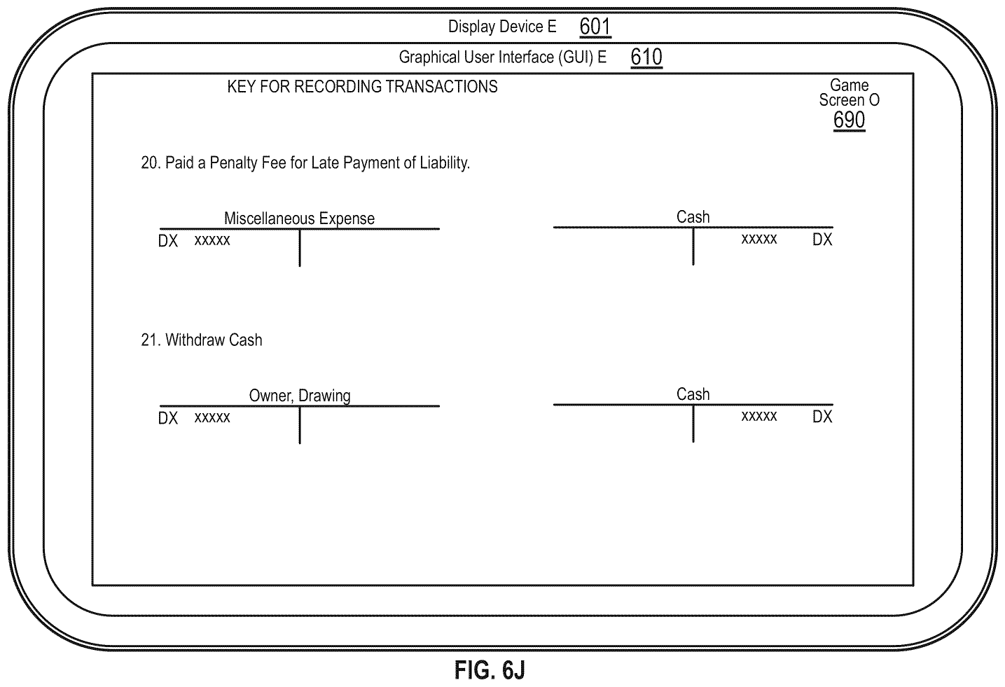

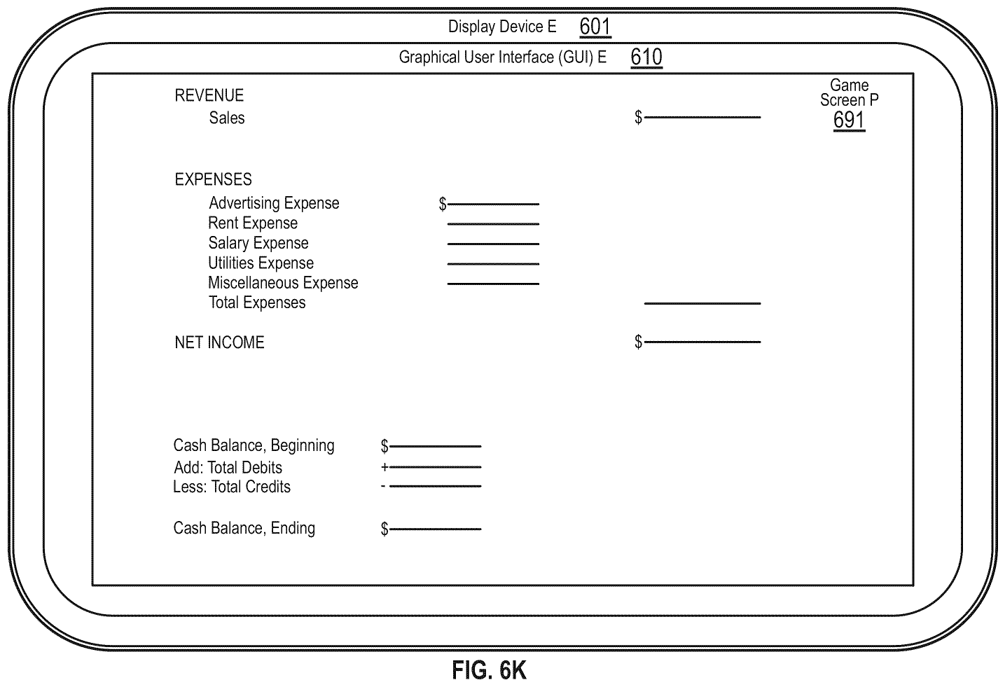

For an electronic accounting game, the transaction rules may correspond to accounting rules for a bookkeeping process (e.g., FIGS. 6A-6H below). In other words, transactional rules may be based on the concept of debits and credits as it is applied all throughout the electronic game. The date of the transaction may be feature in an electronic game that provides a real-world scenario of a bookkeeper, i.e., recording transactions daily to have an updated financial status at the end of the day. Using an electronic ledger, game players may use one or more strategies based on the transactional rules to maintain a good business income where different electronic transactions correspond to different amounts (e.g., different costs and different received payments).

In some embodiments, for example, a game player may record an electronic transaction following the transactional rules of a T-account. A T-account may correspond to a set of financial records that use double-entry bookkeeping. As such, T-account entries in an electronic ledger may be bookkeeping entries that are laid out in a way that resembles a T-shape. Likewise, an account title in a T-account entry may appear just above the T.

In some embodiments, electronic transactions are recorded based on various types of transaction data. Examples of transaction data include asset types (e.g., anything that the service business owns which includes cash, accounts receivable, supplies, prepaid insurance and office equipment), player account receivables (e.g., an amount of cash collectible from a player), customer account receivables (e.g., an amount of cash collectible from a customer), player accounts payable (e.g., amount of cash owed to a player), other accounts payable (e.g., the amount of cash owed to a provider of service and a seller of supplies to the company), an accounting equation (e.g., an equality between assets and the sum of liabilities and owner's equity), a business day (e.g., a day when the business has an operation) capital data (e.g., investment data of the owner of a business), customer data (e.g., personal data or entity data regarding who avails the services of the business), credit data, debit data, and income statement data (e.g., an income statement may provide service business revenue, expenses and net income), liability data (e.g., amounts owed by a service business from suppliers and lenders), miscellaneous expense data (e.g., an expense account to where other expenses can be recorded if no expense account is created for a particular expense), and owner's equity data (e.g., refers to capital, drawing, revenue and expense accounts). In some embodiments, for example, accounting rules include a date of a transaction, determining final balances using a T-account, determining a balance of sales (i.e., total credit to a sales account), and determining a balance of expenses (i.e., total of debit to expenses account). After recording an electronic transaction based on a user input, a user device may transmit a validation request (e.g., validation request X (174)) to an electronic game manager to determine automatically whether the transaction rules were followed by a game player. For examples of T-account data and example T-account entries, see FIGS. 6A-6H and the accompanying description below.

In some embodiments, electronic transactions are recorded in response to game players obtaining one or more digital transaction cards (e.g., digital transaction card X (172), digital transaction cards D (151)). For example, a digital transaction card may define a particular transaction based on predetermined game operations (e.g., a particular digital transaction card may correspond to a payment to a game player or a debt owed to another game player). Likewise, a digital transaction card may be selected based on performing a spinning operation using one or more virtual wheel features (e.g., virtual wheel features E (152)).

In some embodiments, electronic transactions are recorded in an electronic game based on time data. For example, an electronic game may have a selected time period covering a specific number of days, and an electronic transaction may be assigned a specific date in the selected time period. As such, an electronic game may consider the chronological order of recording electronic transactions, such as for determining a game winner using winning criteria (e.g., winning criteria F (153)). Likewise, an electronic game manager may monitor daily recording of electronic transactions, e.g., in a game that proceeds in real-time until completion, or a turn-based game spanning multiple calendar days (such as a turn-based game played over a social networking application). Accordingly, missing dates in bookkeeping may correspond to several accounting problems depending on the context and frequency of such occurrences. Financial reporting without accurate dates may result in electronic transactions that cannot be properly categorized and reflected in financial reports, thereby leading to inaccurate insights and unreliable data for decision-making. For audit issues, auditors may need to rely on dated transactions to verify accuracy and compliance. Undated transactions may raise concerns, potentially prompting additional scrutiny and extending the audit process. For identifying trends, missing dates may make difficult the tracking of spending patterns, analyze particular trends, and identifying areas for business improvement.

Returning to input devices, a user device may also include one or more touchscreens for receiving user inputs. For example, a touchscreen may use capacitive, elastive, resistive, inductive, magnetic, acoustic, ultrasonic, and/or optical techniques for acquiring a touch input from a user. More specifically, a touchscreen may include various sensing elements (e.g., electrodes for transmitting and/or receiving electrical signals). A touchscreen may produce a touch image that span one, two, or three dimensional spaces. A touch image may correspond to a set of measurements of a sensing region where the measurements may be used to determine a particular position of an input object (e.g., a finger or stylus) in the sensing region. For example, in a capacitive embodiment, a capacitive image may include one or more capacitive measurements for different locations of a sensing region. In a resistive sensing embodiment, a touchscreen may include a flexible and conductive first layer separated by one or more spacer elements from a conductive second layer. As such, a user input may be detected by creating one or more voltage gradients are created across the layers and sensing when the first layer is brought in contact with the second layer. As such, pressing the flexible first layer may deflect it sufficiently to create electrical contact between the layers, resulting in voltage outputs reflective of the point(s) of contact between the layers. These voltage outputs may be used to determine positional information of the detected inputs to the touchscreen.

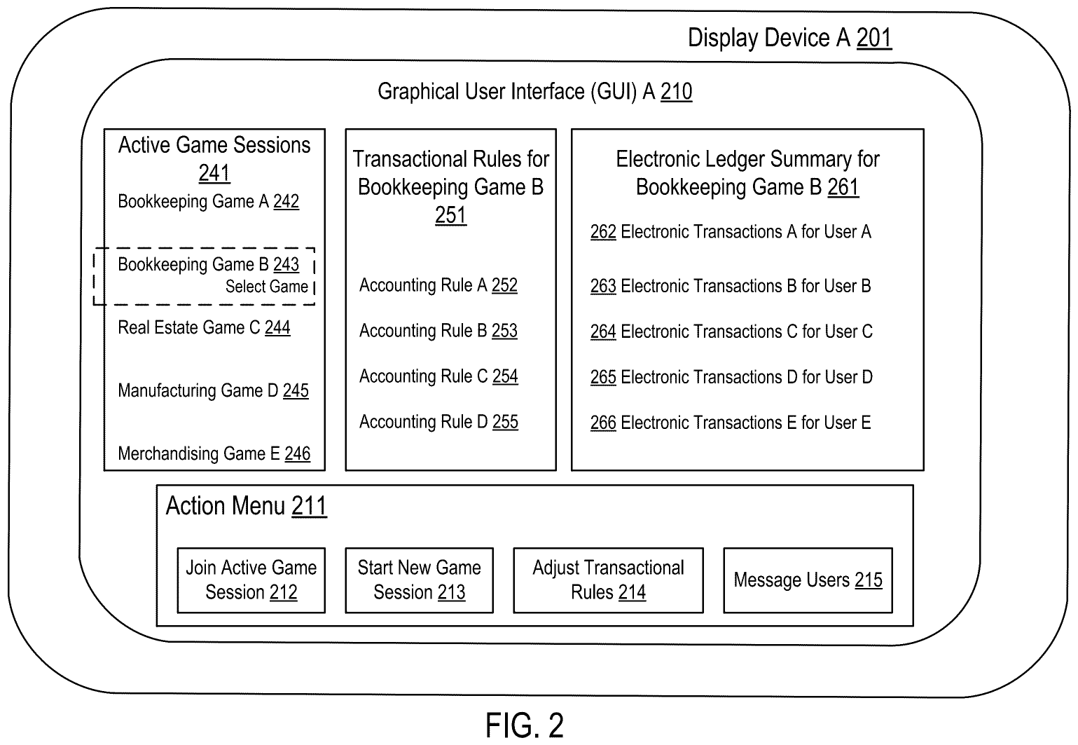

Turning to FIG. 2, FIG. 2 illustrates an example of a graphical user interface for managing one or more game sessions of various electronic games in accordance with one or more embodiments. In FIG. 2, a GUI A (210) is provided on a display device A (201) of a user device (not shown). The GUI A (210) may provide a GUI component that indicates various active game sessions (241) available for different electronic games (e.g., bookkeeping game A (242), bookkeeping game B (243), real estate game C (244), manufacturing game D (245), and merchandising game E (246)). In particular, the active game sessions (241) identify various electronic games currently being provided by an electronic game manager (not shown) and which game players are currently participating. Based on the active game sessions, a user may join an existing electronic game or initiate a new game session for a new electronic game.

Furthermore, the GUI A (210) may provide information on an active game session after being selected by a user. In response to selecting bookkeeping game B (243), the GUI A (210) may provide the transaction rules (251) for the bookkeeping game B (243), such as accounting rule A (252), accounting rule B (253), accounting rule C (254), and accounting rule D (255). As such, different types of business games may have different transactional rules that game players may need to follow in recording different electronic transactions. Likewise, transactional rules may also be modified by game players and/or the electronic game manager, such as updates based on changes in accounting principles or transactional rules for other business game types. Moreover, the GUI A (210) may provide an electronic ledger summary (261) that provide game information regarding electronic ledgers for different game players participating in the selected electronic game. In particular, the electronic ledger summary (261) describes electronic transactions A (262) for user A, electronic transactions B (263) for user B, electronic transactions C (264) for user C, electronic transactions D (265) for user D, and electronic transactions E (266) for user E. As such, a user may monitor the current status of different users playing the electronic game.

Keeping with FIG. 2, in some embodiments, an electronic game manager may provide an action menu (211) to individual users for performing various game operations, e.g., setting up new electronic games as well as managing active game sessions. For example, the action menu (211) may be a GUI window for transmitting one or more commands to an electronic game manager to request specific game operations. As such, the action menu (211) may have one GUI button (212) for joining an active game session, another GUI button (213) for starting a new game session, another GUI button (214) for adjusting transaction rules for a new or active game session, and another GUI button (215) for messaging other users. However, other GUI buttons are contemplated with the GUI, such as GUI buttons that provide real-time notifications to a user (e.g., a request to perform an electronic transaction as well as changes in user balances in a particular game) and GUI buttons for managing controls for performing game operations.

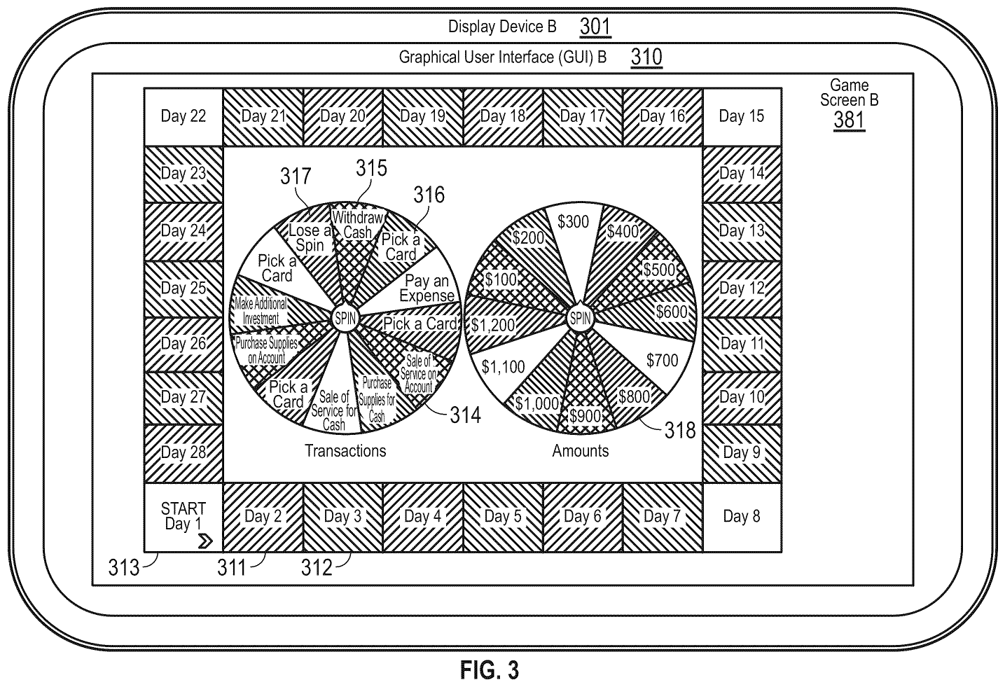

Turning to FIG. 3, FIG. 3 illustrates an example of a graphical user interface for performing game operations in an example electronic game in accordance with one or more embodiments. In FIG. 3, a player may make game selections in a GUI B (310) presented on display device B (301). Such game selections may affect the play of an electronic game. In particular, FIG. 3 shows a game screen B (381) that corresponds to atop view of an electronic game board. The electronic game board is shown with various playing spaces (311) along a game track (312). The playing spaces (311) may be labeled based on a time period (e.g., from day 1 to day 28), where an individual space may represent a specific date when an electronic transaction occurred. For example, day 1 space (313) may be the starting place of the electronic game for each game player.

Keeping with FIG. 3, game players may begin an electronic game with a predetermined amount of money (e.g., $10,000 starting capital). The cash account may be monitored during the electronic game following performance of various electronic transactions. If a player's cash account turns negative (e.g., has paid more liabilities and debts thus exceeding his starting cash amount), the game player may be eliminated from the game. Upon completion of the game track (312), the participants with the highest net income may be deemed the game winner.

In some embodiments, an electronic game includes one or more virtual wheel features (e.g., virtual wheel A (314) and virtual wheel B (318)). For example, virtual wheel A (314) may be a transaction wheel where a game player may provide a user input in GUI B (31) triggering a spinning operation to select an electronic transaction (315) for recording. More specifically, virtual wheel A (314) has a GUI option A (316) to “pick a card” which means the player may obtain a digital card from a deck of transaction cards. Virtual wheel A (314) also has a GUI option B (317) for “losing a spin,” which means the game player may not be able to operate an additional virtual wheel feature (e.g., virtual wheel B (318). In response to losing a spin, no electronic transaction may be recorded during a game round for the respective player (e.g., no electronic transaction on the current day). Otherwise, virtual wheel B (318) may correspond to various amounts (e.g., a range from $100 to $1,200) representing the amount to be recorded for a respective electronic transaction.

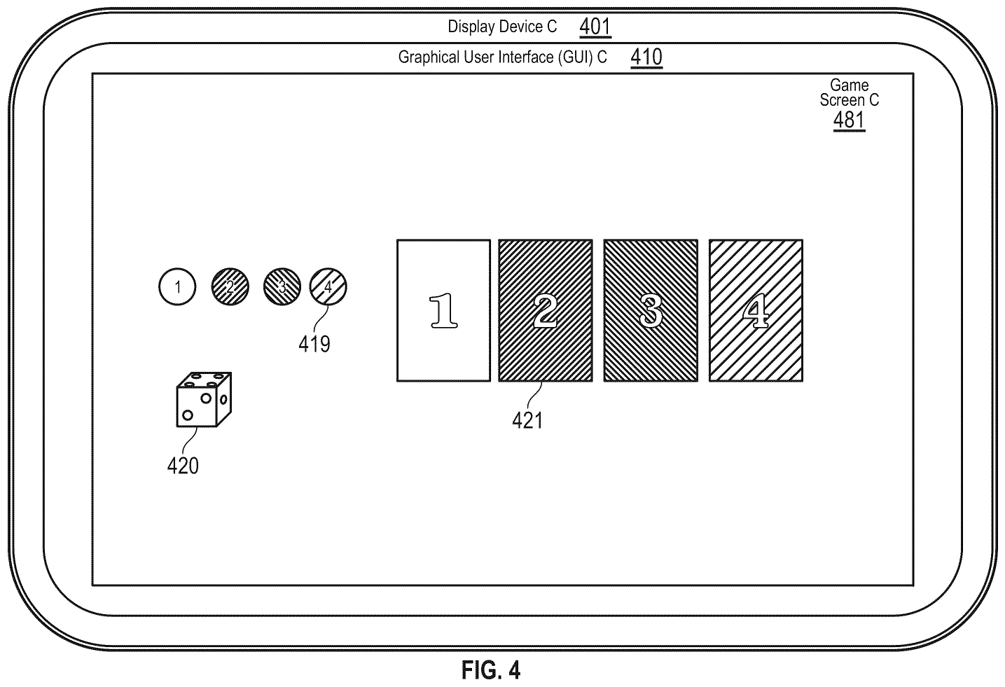

Turning to FIG. 4, FIG. 4 illustrates an example of a graphical user interface for performing game operations in an example electronic game in accordance with one or more embodiments. In FIG. 4, various virtual position tokens (419) are shown with a virtual die (420) in game screen C (481) presented in GUI C (410) on display device C (401) for an electronic game. Four sets of digital card decks (421) are assigned to different players based on their respective token number. The virtual position tokens (419) are disposed on playing spaces in an electronic game similar to playing spaces (311) shown in FIG. 3 and moved along the game track (412). On each turn, the virtual position token (419) may be placed on a designated business day before spinning one or more virtual wheel features. A virtual die (420) may be used to determine the order of turns for each player in a particular game round. Gameplay may begin with each player triggering a game operation with a virtual die (420) to determine the order by which they will operate a virtual wheel feature. After determining the game order, each player may have a designated digital card deck (421), based on their token number. The digital card deck (421) may be randomly sorted by an electronic game manager or locally on a user device.

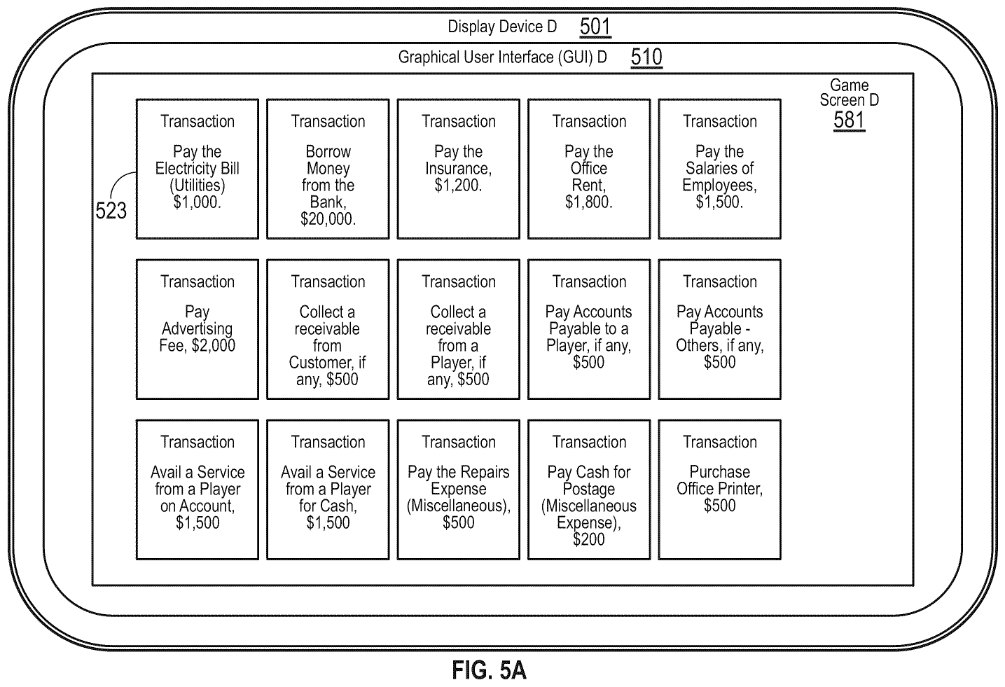

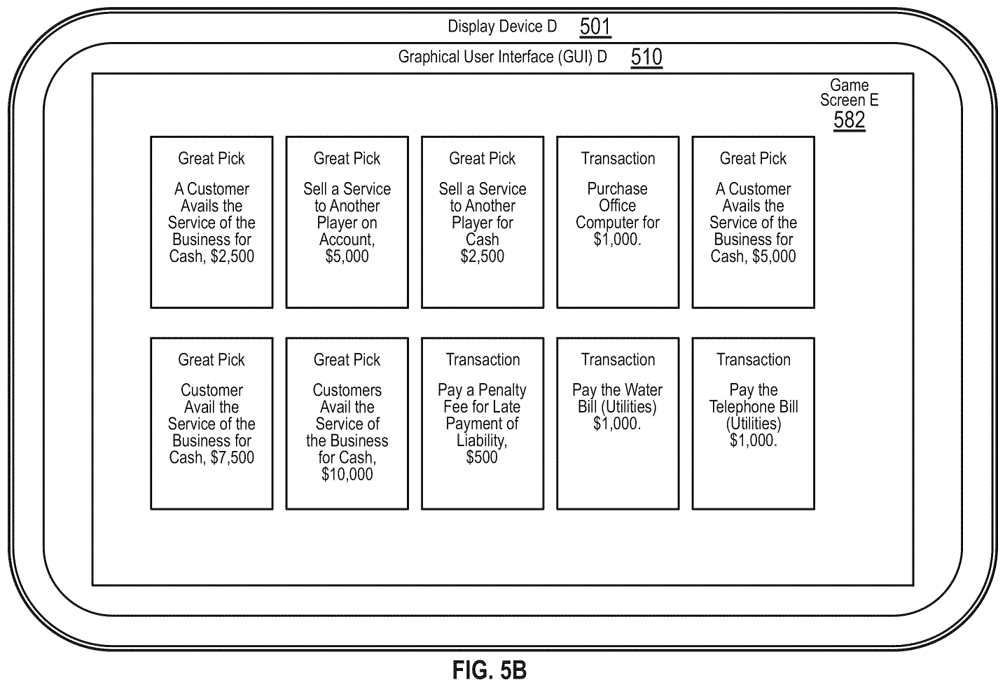

Turning to FIGS. 5A-5B, FIGS. 5A and 5B illustrate an example of a graphical user interface for performing game operations using digital transaction cards in accordance with one or more embodiments. In FIGS. 5A-5B, various digital transaction cards (523) are shown in game screen D (581) and game screen E (582) presented in GUI D (510) on display device D (501) for an electronic game. The presented digital transaction cards (523) may be selected by the player using one or more user inputs (e.g., selecting a GUI component on a touchscreen or another input to an input device). In response to performing a spinning operation with a virtual wheel feature, for example, a card selection operation may be performed by a game player subsequently. A digital transaction card may correspond to a specific type of transaction and a predetermined amount (e.g., $100). After performing the card selection operation, the game player may be presented with a new game screen for recording the electronic transaction in GUI D (510). Likewise, a digital card deck may have a predetermined number of transactions available for a particular electronic game (e.g., 25 total transactions). After a particular player performs an electronic transaction at a particular day (e.g., collecting an account receivable from another game player, if any), the electronic transaction may be recorded by the player, and the next player's turn may begin afterwards.

Turning to FIGS. 6A-6K, FIGS. 6A, 6B, 6C, 6D, 6E, 6F, 6G, 6H, 6I, 6J, and 6K illustrate examples of a graphical user interface for performing various game operations for recording electronic transactions based on digital transaction cards in accordance with one or more embodiments. In FIGS. 6A-6K, a GUI E (610) is presented on a display device E (601) with various game screens (e.g., game screen F (681), game screen G (682), game screen H (683), game screen I (684), game screen J (685), game screen K (686), game screen L (687), game screen M (688), game screen N (689), game screen O (690), game screen P (691)) for recording electronic transactions. In game screen F (681), various GUI fields are shown for assets accounts, while the transaction rules for recording the electronic transactions are shown in various game screens in FIGS. 6F-6J, respectively (e.g., game screen K (686), game screen L (687), game screen M (688), game screen N (689), and game screen O (690)). In particular, the transaction rules may describe rules for recording electronic transactions into debit and credit parts within an electronic ledger. FIG. 6B also shows a game screen G (682) for GUI input fields for accounts receivable accounts, where the transaction rules also correspond to game screen P (691). Additionally, game screen H (683) shows GUI input fields for liabilities accounts, game screen I (684) shows GUI input fields for owner's equity accounts, and game screen J (685) shows GUI input fields for revenue and expense accounts. In FIGS. 6F-6J, various game screens show transaction rules in recording electronic transactions that arise during an electronic game. Where transactional rules are added, deleted, and/or modified (e.g., by an electronic game manager), the updated transactional rules may be shown on similar game screens accordingly.

Turning to FIG. 6K, FIG. 6K shows a game screen P (691) that presents an income statement and cash ending balance computation. As such, digital sales in an electronic game may be reflected in the total of all the credits of sales in a T-account. Thus, amounts of each expense account may be taken from the totals of debits for each expense account in the T-account. The net income may be computed by deducting the total expenses from the sales. The net income may provide a winning criterion for determining the game winner of a particular electronic game. The ending cash balance may be computed by adding the total debits of the cash account to the cash balance beginning and deducting the total credits of the cash account. Cash account values may also serve as a winning criterion for determining a game winner (e.g., in case of a tie amongst two or more game players).

While FIGS. 1, 2, 3, 4, 5A, 5B, and 6A-6K show various configurations of components, other configurations may be used without departing from the scope of the disclosure. For example, various components in FIGS. 1, 2, 3, 4, 5A, 5B, and 6A-6K may be combined to create a single component. As another example, the functionality performed by a single component may be performed by two or more components.

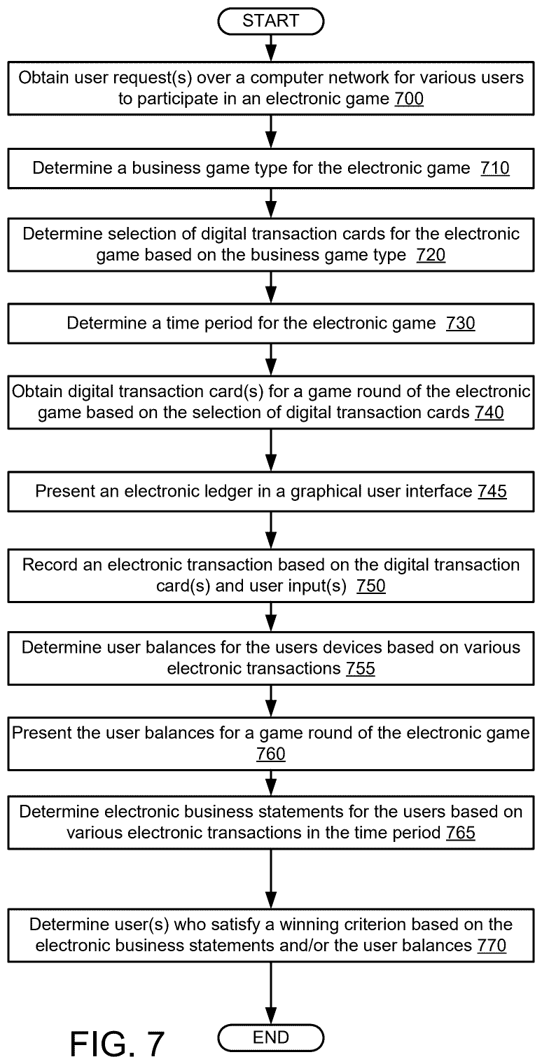

Turning to FIG. 7, FIG. 7 shows a flowchart in accordance with one or more embodiments. Specifically, FIG. 7 describes a general method for performing various game operations for one or more electronic games. One or more blocks in FIG. 7 may be performed by one or more components (e.g., electronic game manager X (150)) as described in FIGS. 1, 2, 3, 4, 5A, 5B, and 6A-6K. While the various blocks in FIG. 7 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 700, one or more user requests are obtained over a computer network for various users to participate in an electronic game in accordance with one or more embodiments. For example, a game player may communicate with an electronic game manager using a user device to request one or more game operations (e.g., join an existing electronic game, perform a game operation in an already joined game, or create a new game session for a new game). The request may be a data message automatically transmitted by the user device in response to one or more input selections within a GUI. In response to receiving a user request, an electronic game manager may automatically perform one or more electronic game operations based on the user request. The user request may be similar to the user request X (171) described above in FIG. 1 and the accompanying description.

In Block 710, a business game type is determined for an electronic game in accordance with one or more embodiments. For example, a gamification approach may be applied to teaching and learning various financial processes, such as financial accounting, real estate transactions, manufacturing businesses, merchandising businesses, and multiple types of bookkeeping. For example, an electronic game may provide one or more gamification exercises as part of classroom learning. In some embodiments, a business game type corresponds to recording business transactions based on one or more double-entry accounting rules. With double-entry accounting rules and accrual accounting, five accounting elements of assets, liabilities, equities, revenue, and expenses. As such, different types of business games may be used to teach entrepreneurship and other business skills and not just bookkeeping skills (e.g., where a winning criterion corresponds to the player having a highest net income for the business in order to win the game).

In Block 720, a selection of digital transaction cards are determined for an electronic game based on a business game type in accordance with one or more embodiments. Depending on a business game type (e.g., real estate transactions, financial accounting for a merchandising company or manufacturing company), an electronic game manager may select digital transaction cards that correspond to available transaction types and transactional rules for the electronic game. Likewise, different user inputs within a graphical user interface may be requested of game players for different electronic games based on different business game type. A complex real estate transaction may require different transactional information then a bookkeeping transaction based on T-accounts.

In Block 730, a time period is determined for an electronic game in accordance with one or more embodiments. For example, a game player may join an active game session based on review the amount of game rounds left in the electronic game. On the other hand, a game player may initiate a new electronic game by setting the number of game rounds as well as the real-time unit corresponding to each game round (e.g., a business day in an electronic game may correspond to three human days). Likewise, some embodiments include electronic games with no definite starting time and ending time, where such game may be continuously played by game players in order to achieve increasing game scores.

In Block 740, one or more digital transaction cards are obtained for a game round of an electronic game based on a selection of digital transaction cards in accordance with one or more embodiments. In case a game player selects a digital transaction card containing “selling a service to a player for cash” or “selling a service to a player on account”, the game player may choose another game player who he/she thinks is ahead of the game, as the other player whom he/she chooses may consider the transaction as an expense. Thus, some embodiments require real-time communication between game players over a network in order to determine in real-time which game player is the target of a digital transaction card. For example, a digital forum may be hosted by an electronic game manager in order to provide feedback amongst players for targeting players with transactions.

In Block 745, an electronic ledger is presented in a graphical user interface in accordance with one or more embodiments. After receiving a digital transaction card, a GUI prompt may be presented on a user device requiring the game player to properly record an electronic transaction. The game player may be able to access from one or more GUI windows information regarding transactional rules for the current electronic game.

In Block 750, an electronic transaction is recorded based on one or more digital transaction cards and one or more user inputs in accordance with one or more embodiments. After providing a user input for an electronic transaction, another game player or an electronic game manager may provide a validation notification whether the electronic transaction was recorded correctly. In some embodiments, a game player may have one or more additional chances to record an electronic transaction in response to a GUI notice that the transaction was performed incorrectly.

In Block 755, various user balances are determined for various user devices based on various electronic transactions in accordance with one or more embodiments. For example, an electronic game may receive notifications during each game round regarding current an amount of cash available for different game players. Likewise, a game player may select another user within a GUI to determine their user balance within the electronic game. Thus, user balances may be used amongst game players for determining transaction targets in order to gain a game advantage.

In Block 760, various user balances are presented for a game round of an electronic game in accordance with one or more embodiments.

In Block 765, various electronic business statements are determined for various users based on various electronic transactions in a time period in accordance with one or more embodiments. Once a time period in an electronic game is completed, game players may receive a GUI indicator showing the results of all of their electronic transactions in comparison to other game players.

In Block 770, one or more users are determined who satisfy a winning criterion based on various electronic business statements and/or various user balances in accordance with one or more embodiments. For example, an electronic game manager may determine a winner of a particular electronic game based on one or more winning criteria. In particular, the winning criteria may be based on a game income statement for each game player after a time period is completed in a specific game (e.g., after the last player's turn on day 28 where the time period corresponds to 28 days). The game income statement may be automatically determined at a user device or an electronic game manager that describes total sales for a respective game player (e.g., all amounts on the credit side of the T-account of sales will be added) and total expenses for the respective game player (e.g., all amounts on the debit of each expense account in the T-account will be added). As such, the game income statement may identify net income for a game player, where total expenses are deducted from total sales. Thus, a winning criterion may correspond to a game player with the highest net income, who may win the electronic game. Likewise, some winning criteria may be used for one or more tie-breakers, such as a higher cash balance be used among game players with the same net income being determined to be the game winner.

In some embodiments, a user device presents a GUI notification indicating the winner of a particular electronic game. In some embodiments, an electronic game has no final winner, and simply continues operating based on new game players joining. For example, some electronic games may have a champion table or player standing screen, which indicates which game players have the highest game score for a particular electronic game. In a social networking game, a game player may continue to obtain game points based on continual playing of the electronic game, but the game player may be surpassed in game points should the game player become idle (e.g., by failing to log into a game system for a predetermined amount of time while other game players continue to play the electronic game).

### Computer System

Embodiments may be implemented on a computer system. FIG. 8 is a block diagram of a computer system (802) used to provide computational functionalities associated with described algorithms, methods, functions, processes, flows, and procedures as described in the instant disclosure, according to an implementation. The illustrated computer (802) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. The illustrated computer (802) is communicably coupled with a network (830). In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802)) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or other suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804 includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), each computer (802) communicating over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

In some embodiments, the computer (802) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining, over a computer network and from a first plurality of user devices, a plurality of user requests to participate in an electronic game;
determining, by a computer processor, a business game type for the electronic game;
determining, by the computer processor, a selection of a plurality of digital transaction cards for the electronic game based on the business game type;
determining, by the computer processor, a selection of a time period for the electronic game;
obtaining a first digital transaction card among the plurality of digital transaction cards for a first game round of the electronic game;
presenting, by the computer processor, an electronic ledger in a graphical user interface that is displayed on a first user device among the first plurality of user devices in response to obtaining the first digital transaction card;
recording, by the computer processor and in response to a first user input to the graphical user interface, a first digital transaction in an electronic ledger based on the first digital transaction card and in response to presenting the electronic ledger in the graphical user interface;
determining, by the computer processor, an electronic business statement based on a plurality of electronic transactions,
wherein the plurality of electronic transactions are recorded in the electronic ledger for the time period; and
determining, by the computer processor, whether a player associated with the first user device satisfies a first winning criterion based on the electronic business statement.

2. The method of claim 1,
wherein the graphical user interface is presented on a touchscreen using a plurality of graphical user interface (GUI) components, and
wherein the first user input is a touch input to at least one GUI component among the plurality of GUI components in the touchscreen.

3. The method of claim 1, further comprising:
obtaining, by a server connected to the computer network, a second plurality of user requests from a second plurality of user devices,
wherein the second plurality of user requests correspond to a plurality of business game types;
assigning, by the server, a first portion of the second plurality of user devices to an electronic manufacturing game based on a first portion of the second plurality of user requests being associated with a manufacturing game type; and
assigning, by the server, a second portion of the second plurality of user devices to an electronic merchandising game based on a second portion of the second plurality of user requests being associated with a merchandising game type,
wherein the plurality of business game types comprise the manufacturing game type and the merchandising game type.

4. The method of claim 1, further comprising:
obtaining, by a server, a recorded electronic transaction from a second user device, wherein the recorded electronic transaction is based on a second user input in response to presenting the electronic ledger in the graphical user interface;
determining, by the server, whether the recorded electronic transaction satisfies a predetermined accounting rule for the electronic game; and
updating, by the server, a game position of the second user device in the electronic game in response to the recorded electronic transaction failing to satisfy the predetermined accounting rule.

5. The method of claim 1, further comprising:
determining a user balance for a second user device based on a plurality of recorded electronic transactions associated with the electronic ledger;
presenting, in the graphical user interface, the user balance to a plurality of user devices during a second game round;
determining whether the user balance satisfies a second winning criterion; and
terminating the electronic game for the second user device in response to the user balance failing to satisfy the second winning criterion.

6. The method of claim 5,
wherein the second winning criterion corresponds to a positive cash amount, and
wherein the electronic game is terminated for the second user device in response to a negative cash amount.

7. The method of claim 1,
wherein the first winning criterion corresponds to a second user device among a plurality of user devices with a highest net income among a plurality of valid recorded transactions in the electronic ledger.

8. The method of claim 1,
wherein the plurality of digital transaction cards comprises a second digital transaction card and a third digital transaction card,
wherein the second digital transaction card corresponds to a payment of a player liability by a first user during a predetermined first day within the time period, and
wherein the third digital transaction card corresponds to receipt of a payment for a player service by the first user during a predetermined second day within the time period.

9. The method of claim 1, further comprising:
determining a first player token for the first user device;
obtaining, using a first virtual wheel feature, a second digital transaction card in response to disposing the first player token on a predetermined first day within the time period; and
performing a first electronic transaction on the predetermined first day for the first user device based on the second digital transaction card.

10. The method of claim 9, further comprising:
obtaining, using a second virtual wheel feature, a third digital transaction card in response to obtaining the second digital transaction card using the first virtual wheel feature,
wherein the second digital transaction card corresponds to a payment of a player liability and the third digital transaction card corresponds to a cost of the player liability.

11. The method of claim 1, further comprising:
performing a plurality of game operations by a plurality of game players over the time period,
wherein the plurality of game operations are administered by an electronic game manager.

12. A system, comprising:
a computer network;
a first plurality of user devices coupled over the computer network;
an electronic game manager coupled to the first plurality of user devices over the computer network, wherein the electronic game manager comprises a computer processor and is configured to perform a method comprising:
obtaining, over the computer network and from the first plurality of user devices, a plurality of user requests to participate in an electronic game;
determining a business game type for the electronic game;
determining a selection of a plurality of digital transaction cards for the electronic game based on the business game type;
determining a selection of a time period for the electronic game;
obtaining a first digital transaction card among the plurality of digital transaction cards for a first game round of the electronic game;
presenting an electronic ledger in a graphical user interface that is displayed on a first user device among the first plurality of user devices in response to obtaining the first digital transaction card;
recording, in response to a first user input to the graphical user interface, a first electronic transaction in an electronic ledger based on the first digital transaction card and in response to presenting the electronic ledger in the graphical user interface;
determining an electronic business statement based on a plurality of electronic transactions,
wherein the plurality of electronic transactions are recorded in the electronic ledger for the time period; and
determining whether a player associated with the first user device satisfies a first winning criterion based on the electronic business statement.

13. The system of claim 12,
wherein the first user device comprises a touchscreen,
wherein the graphical user interface is presented on the touchscreen using a plurality of graphical user interface (GUI) components, and
wherein the first user input is a touch input to at least one GUI component among the plurality of GUI components in the touchscreen.

14. The system of claim 12, wherein the method further comprises:
obtaining a second plurality of user requests from a second plurality of user devices,
wherein the second plurality of user requests correspond to a plurality of business game types;
assigning a first portion of the second plurality of user devices to an electronic manufacturing game based on a first portion of the second plurality of user requests being associated with a manufacturing game type; and
assigning a second portion of the second plurality of user devices to an electronic merchandising game based on a second portion of the second plurality of user requests being associated with a merchandising game type,
wherein the plurality of business game types comprise the manufacturing game type and the merchandising game type.

15. The system of claim 12, wherein the method further comprises:
obtaining a recorded electronic transaction from a second user device, wherein the recorded electronic transaction is based on a second user input in response to presenting the electronic ledger in the graphical user interface;
determining whether the recorded electronic transaction satisfies a predetermined accounting rule for the electronic game; and
updating a game position of the second user device in the electronic game in response to the recorded electronic transaction failing to satisfy the predetermined accounting rule.

16. The system of claim 12, wherein the method further comprises:
determining a user balance for a second user device among a second plurality of user devices based on a plurality of recorded electronic transactions associated with the electronic ledger;
presenting, in the graphical user interface, the user balance to a second plurality of user devices during a second game round;
determining whether the user balance satisfies a second winning criterion; and
terminating the electronic game for the second user device in response to the user balance failing to satisfy the second winning criterion.

17. The system of claim 12,
wherein the first winning criterion corresponds to a second user device among a plurality of user devices with a highest net income among a plurality of valid recorded transactions in the electronic ledger.

18. The system of claim 12,
wherein the plurality of digital transaction cards comprises a second digital transaction card and a third digital transaction card,
wherein the second digital transaction card corresponds to a payment of a player liability by a first user during a predetermined first day within the time period, and
wherein the third digital transaction card corresponds to receipt of a payment for a player service by the first user during a predetermined second day within the time period.

19. The system of claim 12, wherein the method further comprises:
determining a first player token for the first user device;
obtaining, using a first virtual wheel feature, a second digital transaction card in response to disposing the first player token on a predetermined first day within the time period; and
performing a first electronic transaction on the predetermined first day for the first user device based on the second digital transaction card.

20. The system of claim 19, wherein the method further comprises:
obtaining, using a second virtual wheel feature, a third digital transaction card in response to obtaining the second digital transaction card using the first virtual wheel feature,
wherein the second digital transaction card corresponds to a payment of a player liability and the third digital transaction card corresponds to a cost of the player liability.
